(19) United States
(12) Patent Application Publication
(10) Pub. No.: US 2012/0200882 A1
(43) Pub. Date: Aug. 9, 2012

(54) INFORMATION PROCESSING APPARATUS, METHOD FOR CONTROLLING SAME, AND STORAGE MEDIUM

(75) Inventor: Koji Ito, Inagi-shi (JP)

(73) Assignee: CANON KABUSHIKI KAISHA, Tokyo (JP)

(21) Appl. No.: 13/349,388

(22) Filed: Jan. 12, 2012

(30) Foreign Application Priority Data
Feb. 9, 2011 (JP) 2011-025630

(51) Int. Cl. G06K 15/02

(52) U.S. Cl. 358/1.15; 358/1.16

(57) ABSTRACT

A user setting generation unit generates a user setting by eliminating a conflict between print settings corresponding to a printer, and associates the user setting with a PPD file using identification information about the user setting to store the associated user setting in a user setting save file. An application displays a print setting in the PPD file and identification information about the user setting on a print setting dialogue. When identification information has been selected, the application passes identification information to a PS filter program, and the PS filter program makes a print setting using a user setting that is stored in a user setting save file and is associated with the identification information.

### BACKGROUND OF THE INVENTION

1. Field of the Invention

The present invention relates to an information processing apparatus, a method for controlling the same, and a storage medium.

2. Description of the Related Art

A typical print system including a host computer and a printer has been proposed. In the print system, a user makes a print setting using, for example, a print setting dialogue activated by an application included in the host computer. The print setting dialogue is a UI (User Interface) screen for making a print setting. The print system makes a print setting in accordance with a user's operation on the print setting dialogue.

Examples of items (setting items) settable using the print setting dialogue include a large number of items such as paper type, paper size, image processing method, color adjustment parameters, print quality, and the like. In the following, a value that is selectable corresponding to a setting item is described as a “set value”. In an inkjet printer, a print result changes by a large amount depending on the selected set value. Thus, it is important that a print setting is made depending on the application.

For the setting items, there are some combinations of set values that cannot be set simultaneously because of a mutually-dependent relationship or a mutually-exclusive relationship. If a user selects the combination of set values that cannot be set simultaneously, a mismatch in print settings may occur. Thus, the print setting dialogue needs to execute processing so as to avoid a mismatch in print settings. The configuration of the print setting dialogue may vary depending on an OS (Operating System) or a print system. Therefore, processing to be performed to avoid a mismatch in print settings may vary depending on a system environment.

On the print setting dialogue provided in a print system running on Windows (registered trademark) by Microsoft Corporation, a unique program for printer manufacturers performs processing for avoiding a mismatch in print settings. The unique program for printer manufacturers holds a combination of valid set values as database, and, when a combination of mismatched set values has been selected, provides a warning to a user to prompt a change in set values. Alternately, the program controls the print setting dialogue so as not to display a combination of mismatched set values.

Also, on the print setting dialogue in a CUPS (registered trademark) running on MacOS X (registered trademark) by Apple Inc. or Linux (registered trademark), the API for CUPS is used to perform processing for avoiding a mismatch in set values, where CUPS is an abbreviation for Common UNIX (registered trademark) Printing System.

In the CUPS, two set values that cannot be set simultaneously can be described in a PPD (registered trademark) file in a UIConstraints format, where PPD is an abbreviation for PostScript Printer Description. The application of the print system acquires information about set values, which cannot be set simultaneously and are described in UlConstraints of the PPD file, via the API of the CUPS to thereby avoid a mismatch in set values. Because of the CUPS specifications, three or more set values cannot be described in UlConstraints. Thus, for three or more set values that cannot be set simultaneously, the CUPS cannot prevent a combination of such set values from being selected. In order to solve the problems, Japanese Patent Laid-Open No. 2009-163680 discloses information processing apparatus that eliminates a mismatch in print settings by defining a plurality of setting items as one setting item.

In order for the application to prevent a mismatch in print settings appropriately based on information about set values that has been acquired via the API of the CUPS and cannot be set simultaneously, the application must be implemented in accordance with certain rules for preventing a mismatch in print settings.

For example, under the system environment operating under the OS such as MacOS X, an implementation rule for application for appropriately preventing a mismatch in print settings is serviced by the OS manufactures. Thus, under such a system environment, processing for preventing a mismatch in print settings is normally operated. However, for example, under the system environment running under Linux (registered trademark), the degrees of freedom in implementation of an application are high, and thus, the implementation rule is not well serviced. Under such a system environment, processing for preventing a mismatch in print settings may not be normally operated. Therefore, under the system environment having a high degree of freedom in implementation of an application, the print setting dialogue must display only the setting items of the minimum necessary limits so as to prevent a mismatch in print settings from being occurred as much as possible. When the print setting dialogue display only the setting items of the minimum necessary limits, the print system can only set a part of setting items, whereby the print system cannot execute desired printing.

### SUMMARY OF THE INVENTION

The information processing apparatus of the present invention is an apparatus for making print settings, and makes the print settings regarding the setting items which are not displayed on a print setting dialogue to be activated by an application and prevents a mismatch in print settings as well.

According to an aspect of the present invention, an information processing apparatus that performs a print setting for print processing executed by a print device is provided that includes a first storage unit configured to store information including a first print setting corresponding to the print device in advance; a second storage unit configured to store information including a second print setting, which is a print setting corresponding to the print device, in which a conflict state between print settings has been eliminated; and a print setting unit configured to perform a print setting for print processing using the first print setting or the second print setting, wherein, when an application that selectably displays a print setting included in the first print setting stored in the first storage unit on a screen and receives control information indicating whether or not a print setting for print processing executed by the print device is made using either the print setting included in the first print setting selected on the screen or the second print setting stored in the second storage unit receives control information indicating that a print setting for print processing executed by the print device is made using the print setting included in the first print setting selected on the screen, the print setting unit makes a print setting for the print processing using the selected print setting, or when the application receives control information indicating that a print setting for print processing executed by the print device is made using the second print setting, the print setting unit makes a print setting for print processing using the second print setting stored in the second storage unit.

Further features of the present invention will become apparent from the following description of exemplary embodiments with reference to the attached drawings.

### BRIEF DESCRIPTION OF THE DRAWINGS

FIG. 1 is a diagram illustrating an example of a system configuration of the present embodiment.

FIG. 2 is a functional block diagram of a computer.

FIGS. 3A to 3C are diagrams illustrating an example of description of a PPD file.

FIGS. 4A and 4B are diagrams illustrating an example of a print setting dialogue.

FIGS. 5A to 5D are diagrams illustrating an example of a user setting generation dialogue.

FIG. 6 is a flowchart illustrating user setting generation processing.

FIG. 7A is a diagram illustrating an example of a PPD file.

FIG. 7B is a diagram illustrating an example of user setting.

FIG. 7C is a diagram illustrating an example of a print setting dialogue.

FIG. 8 is a flowchart illustrating PS filter program operation processing.

FIG. 9 is a diagram illustrating an example of description of a PPD file in the initial state.

FIGS. 10A and 10B are diagrams illustrating an example of description of user setting in the initial state.

FIG. 11 is a diagram illustrating an example of a print setting dialogue.

### DESCRIPTION OF THE EMBODIMENTS

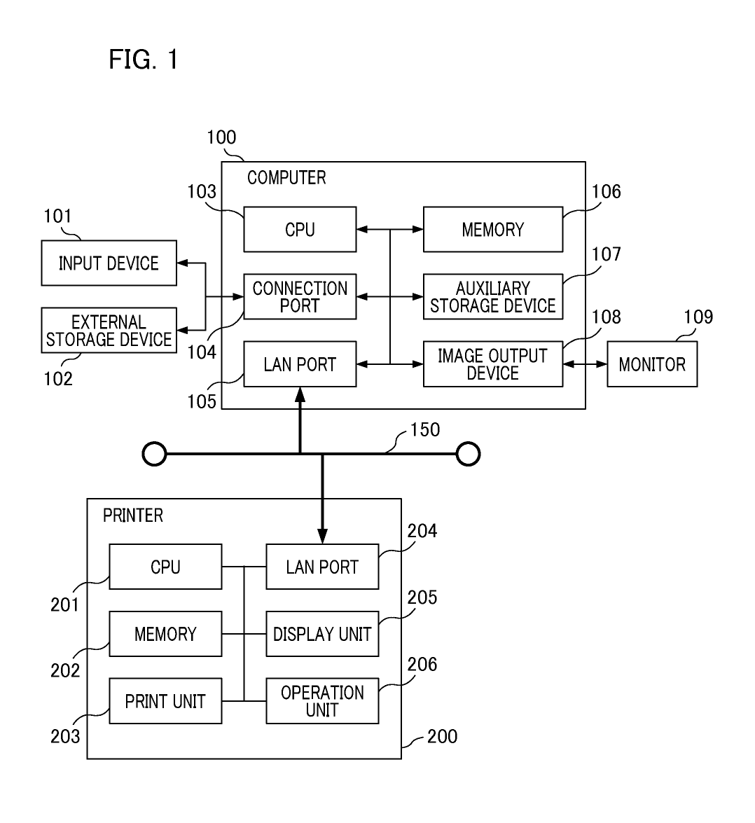

FIG. 1 is a diagram illustrating an example of a system configuration of the present embodiment. The system of the present embodiment includes a computer 100 and a printer 200 that are communicatably connected to each other via a network 150. The number of the printers 200 may be one or plural. The computer 100 and the printer 200 communicate each other in accordance with a TCP (Transmission Control Protocol/IP (Internet Protocol)) protocol. Note that the computer 100 and the printer 200 may communicate each other via I/F (Interface) other than the network 150, such as a USB (Universal Serial Bus) or the like.

The computer 100 generates print data, transmits the generated print data to the printer 200, and instructs the printer 200 to perform print processing for the print data. Print data is print data to be subject to print processing by the printer 200. The computer 100 makes a print setting for print processing executed by the printer 200, and generates print data corresponding to the print setting. In other words, the computer 100 is an information processing apparatus that makes a print setting for print processing executed by the printer 200. The printer 200 is a print device that prints print data in accordance with an instruction given by the computer 100.

The computer 100 includes a CPU (Central Processing Unit) 103 and a connection port 104. Also, the computer 100 includes a LAN (Local Area Network) port 105, a memory 106, an auxiliary storage device 107, and an image output device 108.

The CPU 103 controls the computer 100 overall. The connection port 104 is connected to the peripheral devices. For example, an input device 101 such as a keyboard, a mouse, or the like and an external storage device 102 such as a USB memory, an external hard disk, a CD-ROM, a DVD-ROM, or the like are connected to the connection port 104. The connection port 104 is, for example, a serial port or a USB port.

The LAN port 105 connects the computer 100 to a network. The auxiliary storage device 107 stores various control programs such as a printer driver, an application, or the like in advance. The auxiliary storage device 107 is, for example, a memory 106, a hard disk, or the like. The image output device 108 outputs various information on a screen. The memory 106 is a storage unit (for example, a random access memory) at which the work area of the CPU 103 is expanded. A monitor 109 is connected to the output terminal of the image output device 108.

The printer 200 includes a CPU 201, a memory 202, a print unit 203, a LAN port 204, a display unit 205, and an operation unit 206. The CPU 201 controls a printer overall. The memory 202 is a storage unit that is employed as a work area upon execution of processing performed by the print unit 203. The print unit 203 receives print data from the computer 100 via the LAN port 204, and performs print processing for forming an image on a print medium based on the received print data. The LAN port 204 connects the printer 200 to the network 150. The display unit 205 displays the user interface (UI) to be operated by a user or the operating status of the printer 200 on a screen. The operation unit 206 inputs information corresponding to a user's operation on the UI.

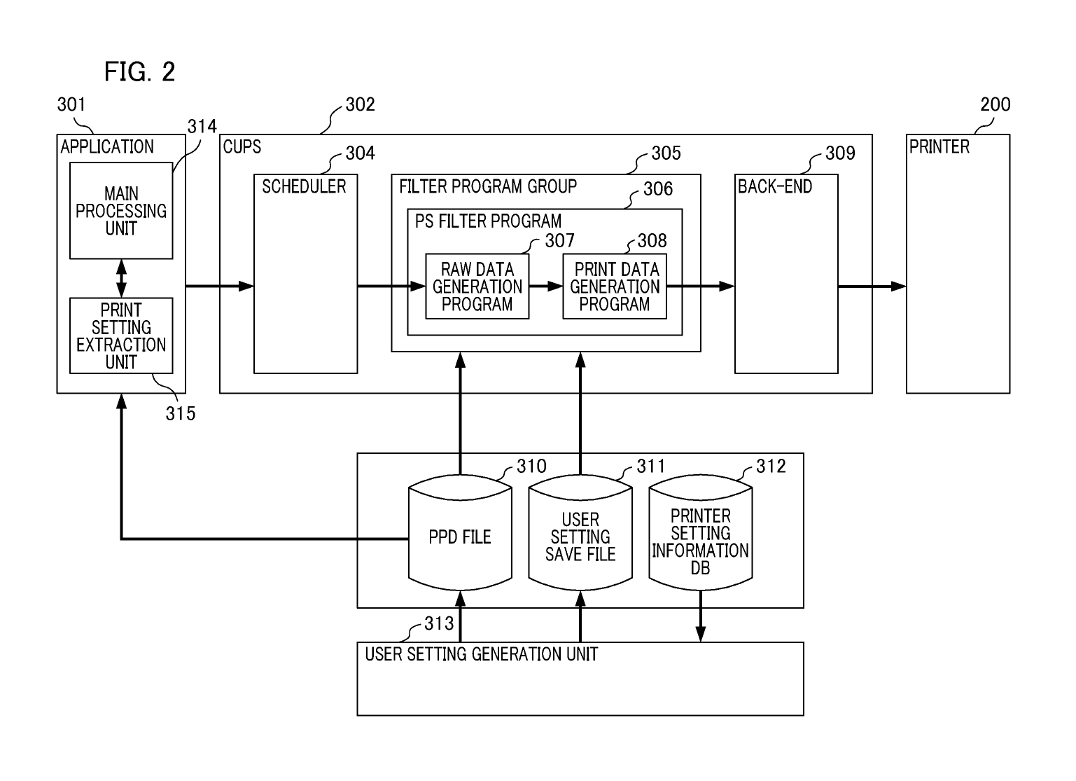

FIG. 2 is a functional block diagram of a computer. The computer 100 includes an application 301, a CUPS 302, a user setting generation unit 313, a PPD file 310, a user setting save file 311, and a printer setting information database (DB) 312. The application 301, the CUPS 302, and the user setting generation unit 313 are stored in the auxiliary storage device 107 in advance. Also, the PPD file 310, the user setting save file 311, and the printer setting information database 312 are stored in the auxiliary storage device 107 in advance. The CPU 103 provided in the computer 100 expands the application 301, the CUPS 302, and the user setting generation unit 313 from the auxiliary storage device 107 to the memory 106 to thereby execute the application 301, the CUPS 302, and the user setting generation unit 313. With this arrangement, a method for controlling the information processing apparatus of the present embodiment is realized. Also, the computer program of the present embodiment causes a computer to execute a method for controlling the information processing apparatus.

The application 301 generates print data. Also, the application 301 selects information regarding a print setting corresponding to the generated print data. More specifically, the application 301 receives information regarding a print setting in accordance with a user's operation on a print setting dialogue to be described below, and selects the received information. Information regarding a print setting functions as control information that indicates whether or not a print setting for print processing executed by the printer 200 is made using either a print setting included in the PPD file 310 or a user setting stored in the user setting save file 311.

The application 301 passes information regarding print data and the print setting to the CUPS 302. The CUPS 302 generates print data based on information regarding print data and the print setting that have been passed from the application 301. The CUPS 302 transmits print data to the printer 200, and causes the printer 200 to execute print processing for the print data.

The PPD file 310 functions as a first storage unit that stores information including a print setting (first print setting) corresponding to a printer in advance. The application 301 includes a main processing unit 314 and a print setting extraction unit 315. The print setting extraction unit 315 acquires a PPD file corresponding to the printer 200, which executes the specified print processing, among PPD files stored in the auxiliary storage device 107. For this purpose, the user setting generation unit 313 or a predetermined processing unit (not shown) provided in the computer 100 generates information (for example, queue in Linux (registered trademark)) indicating the printer 200. Then, the print setting extraction unit 315 displays, for example, a queue indicating the printer 200 on a predetermined UI screen.

The user setting generation unit 313 or a predetermined processing unit generates, for example, a queue indicating the printer 200 by executing the following 1padmin command.

#1padmin −p “queue name” −m “PPD file name” −v “back-end name: device” −E

When an 1padmin command is executed, a queue indicating the printer 200, the name of the PPD file 310, and the name of the back-end 309 are registered in the CUPS 302. Also, when an 1padmin command is executed, a PPD file corresponding to the printer 200 is copied into a predetermined storage unit provided in the CUPS 302.

When a user refers to a queue on a UI screen and selects a queue of the printer 200 for which the user wishes to execute print processing, the print setting extraction unit 315 acquires a PPD file corresponding to the printer 200 indicated by the selected queue. More specifically, the print setting extraction unit 315 acquires a PPD file, which has been copied into the CUPS 302, via the API of the CUPS 302.

The print setting extraction unit 315 selectably displays print settings (setting items and set values) included in a first print setting described in the acquired PPD file on a print setting dialogue. The print setting dialogue is a UI (User Interface) screen that selects and operates the print settings. Also, the setting items are the items of print settings during print processing. A set value is a value corresponding to a setting item. In the present embodiment, the application 301 does not execute processing for eliminating a mismatch (conflict) in print settings. Thus, the number of setting items and set values, which the print setting extraction unit 315 can display on the print setting dialogue, is limited to a predetermined number thereof. For example, the print setting extraction unit 315 displays setting items such as “paper size”, “paper type”, and “paper-feeding method”.

The main processing unit 314 generates print data. In the present embodiment, the main processing unit 314 is PS (PostScript) data. The main processing unit 314 may generate data in another format (for example, PDF data) as print data. Also, the main processing unit 314 selects information regarding print settings in accordance with a user's operation on a print setting dialogue. The main processing unit 314 converts information regarding the selected print settings into the option format of the CUPS 302. Then, the main processing unit 314 passes PS data and information regarding the print settings, which has been converted into the option format of the CUPS 302, to the CUPS 302.

The CUPS 302 includes a scheduler 304, a filter program group 305, and a back-end 309. The scheduler 304 receives PS data and information regarding print settings from the main processing unit 314 of the application 301. The scheduler 304 confirms the data format of the received PS data, and converts PS data into an input data format that can be processed by a PS filter program 306. The PS filter program 306 is a program that finally generates print data. The data conversion is performed in conjunction with a filter program pre-stored in the filter program group 305. The name of a program for finally generating print data and the input data format of the program are described in the PPD file 310 in advance. The scheduler 304 passes PS data of which the data format has been converted to the PS filter program 306. Also, the scheduler 304 passes information regarding print settings to the PS filter program 306.

The filter program group 305 includes a plurality of filter programs. The filter program group 305 includes at least the PS filter program 306 that serves as a filter for converting PS data into print data.

In the present embodiment, the PS filter program 306 functions as a print setting unit that performs a print setting for print processing executed by a printer. The PS filter program 306 includes a RAW data generation program 307 and a print data generation program 308. The RAW data generation program 307 converts PS data, which has been received from the scheduler 304, into each-color 8-bit RGB RAW data. Also, the RAW data generation program 307 acquires a print setting corresponding to information regarding print settings, which has been received from the scheduler 304, and passes the print setting to the print data generation program 308.

The print data generation program 308 refers to an option format conversion table, and converts the print setting received from the RAW data generation program 307 into the option format of the print data generation program 308. The option format conversion table is described in a PPD file copied in the CUPS 302.

The print data generation program 308 applies the print setting to RAW data, and converts RAW data into print data that is printable by the printer 200. With this arrangement, print data is generated. The print data generation program 308 passes the generated print data to the back-end 309. The back-end 309 transmits print data to the printer 200, and instructs the printer 200 to perform print processing for the print data.

The user setting generation unit 313 generates a user setting, and stores the user setting in the user setting save file 311. The user setting includes setting items supported (handled) by the printer 200 and set values corresponding to the setting items. The user setting functions as a second print setting. Also, the user setting generation unit 313 functions as an association unit that associates a user setting with identification information about the user setting to store the associated user setting in the user setting save file 311. Identification information about a user setting is identification information for uniquely identifying a user setting.

More specifically, the user setting generation unit 313 displays a user setting generation dialogue as a UI screen, and generates a user setting in accordance with a user's selection operation on the user setting generation dialogue.

After each time a user's selection operation has been made, the user setting generation unit 313 eliminates a conflict between the selected setting items based on the setting items and set values both included in the user setting made after the selection operation and conflict-related information pre-stored in the printer setting information DB 312. Conflict-related information is information regarding setting items and set values in which a mismatch between the setting items occurs when the set values are set. In other words, the user setting generation unit 313 functions as a conflict elimination unit that executes processing for eliminating a conflict state between print settings corresponding to a printer to thereby generate a user setting.

The user setting generation unit 313 sets, for example, the setting items and set values between which a conflict has been eliminated as a user setting, and associates the user setting with identification information to thereby store the associated user setting in the user setting save file 311. In other words, the user setting save file 311 functions as a second storage unit that stores information including a second print setting, which is a print setting corresponding to a printer, in which a conflict state between print settings has been eliminated. In the present embodiment, it is assumed that the number of setting items included in a user setting is greater than the number of setting items to be displayed on a print setting dialogue.

Also, the user setting generation unit 313 describes user setting identification information included in the user setting stored in the user setting save file 311 in a PPD file corresponding to the printer 200 among the PPD file(s) 310. With this arrangement, the user setting stored in the user setting save file 311 and the print setting stored in the PPD file 310 are associated to each other using user setting identification information.

The user setting generation unit 313 executes an 1padmin command, and updates the PPD file copied in the CUPS 302 with the PPD file associated with the user setting. The print setting extraction unit 315 displays a print setting dialogue in accordance with the description content of the PPD file copied in the CUPS 302. With this arrangement, identification information about the user setting is selectably displayed on the print setting dialogue. The printer setting information DB 312 stores conflict-related information in advance. Also, the printer setting information DB 312 stores default set values for setting items in advance.

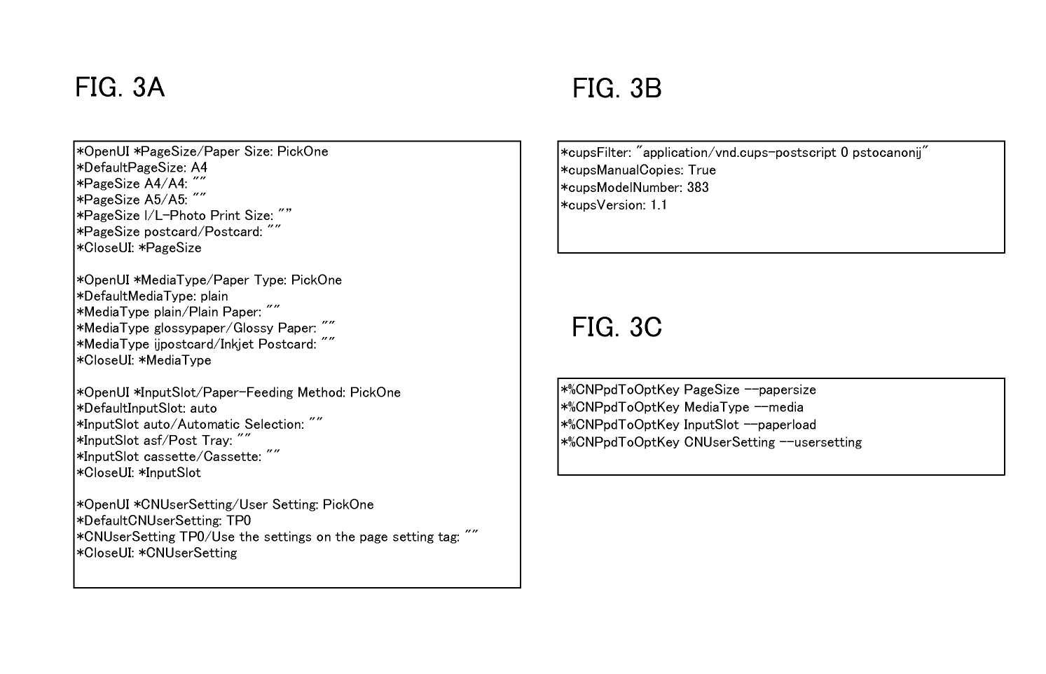

FIG. 3 is a diagram illustrating an example of description of a PPD file. FIG. 3A shows an example of description of setting items and set values included in a PPD file. The print setting extraction unit 315 displays, for example, predetermined setting items and set values on a print setting dialogue among the setting items and set values shown in FIG. 3A.

The term “*OpenUI*PageSize/paper size: PickOne” is a description that is employed by the print setting extraction unit 315 for displaying the “paper size” as a setting item. Each row starting with “*PageSize” is a description for representing the set value of the setting item “paper size”. Each row starting with “*DefaultPageSize” is a description for representing the fact that the default value of a setting item is “A4”. In accordance with the description content shown in FIG. 3A, the print setting extraction unit 315 displays a “paper size”, a “paper type”, a “paper-feeding method”, and a “user setting” as setting items.

Also, the print setting extraction unit 315 displays “A4”, “A5”, “L-photo print size”, and “postcard” as the set values for the setting item “paper size” on a print setting dialogue in accordance with the description content shown in FIG. 3A. A user can select one of these set values on the print setting dialogue. For the setting item “user setting”, there is only one set value “use the settings on the page setting tag” in the initial state in which the PPD file 310 is stored in the auxiliary storage device 107.

FIG. 3B shows the name of a program for finally generating print data and the input data format of the program, both of which are described in a PPD file. A description will be given of description “*cupsFilter:” application/vnd.cups-postscript 0 pstocanonij“”. The description “pstocanonij” is the name of a program for finally generating print data, i.e., the name of the PS filter program 306. The description “vnd.cups-postscript” is the input data format of “pstocanonij”.

FIG. 3C shows an example of an option format conversion table described in a PPD file. A description will be given of description “*%CNPpdToOptKey PageSize--papersize”. The description “PageSize” is the option format of information regarding print settings, which is passed from the application 301 to the CUPS 302. The description “--papersize” is the option format that corresponds to the print data generation program 308.

For example, when a user selects “A4” as the set value of the setting item “paper size” on the print setting dialogue, the application 301 passes the set value to the CUPS 302 in the option format of “−o “ PageSize=A4””. The PS filter program 306 receives the option format. The PS filter program 306 converts the received option format into the option format of “--papersize A4” based on the option format conversion table shown in FIG. 3C and passes the resulting option format to the print data generation program 308.

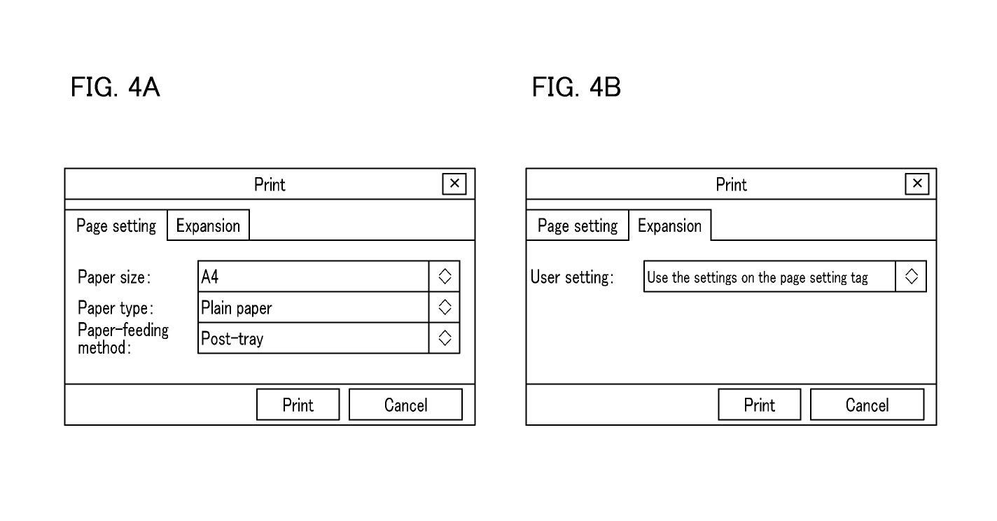

FIG. 4 is a diagram illustrating an example of a print setting dialogue. The print setting dialogue has two tabs: “page setting” and “extension”. FIG. 4A shows the UI configuration of the “page setting” tab. The print setting extraction unit 315 displays the setting items and set values described in a PPD file on the “page setting” tab. The print setting extraction unit 315 selectably displays the set values in the pull-down format. Among the setting items described in the PPD file, the print setting extraction unit 315 displays typical setting items such as “paper size”, “paper type”, “paper-feeding method”, or the like on the “page setting” tab.

FIG. 4B shows the UI configuration of the “extension” tab. Among the setting items described in the PPD file, the print setting extraction unit 315 displays a setting item not to be displayed on the “page setting” tab on the “extension” tab. In the example shown in FIG. 4B, the print setting extraction unit 315 displays the setting item “user setting” on the “extension” tab. In the initial state in which the PPD file 310 is stored in the auxiliary storage device 107, a set value corresponding to the setting item “user setting” is only “use the settings on the page setting tag”. Thus, the print setting extraction unit 315 displays “use the settings on the page setting tag” as a set value corresponding to the setting item “user setting”.

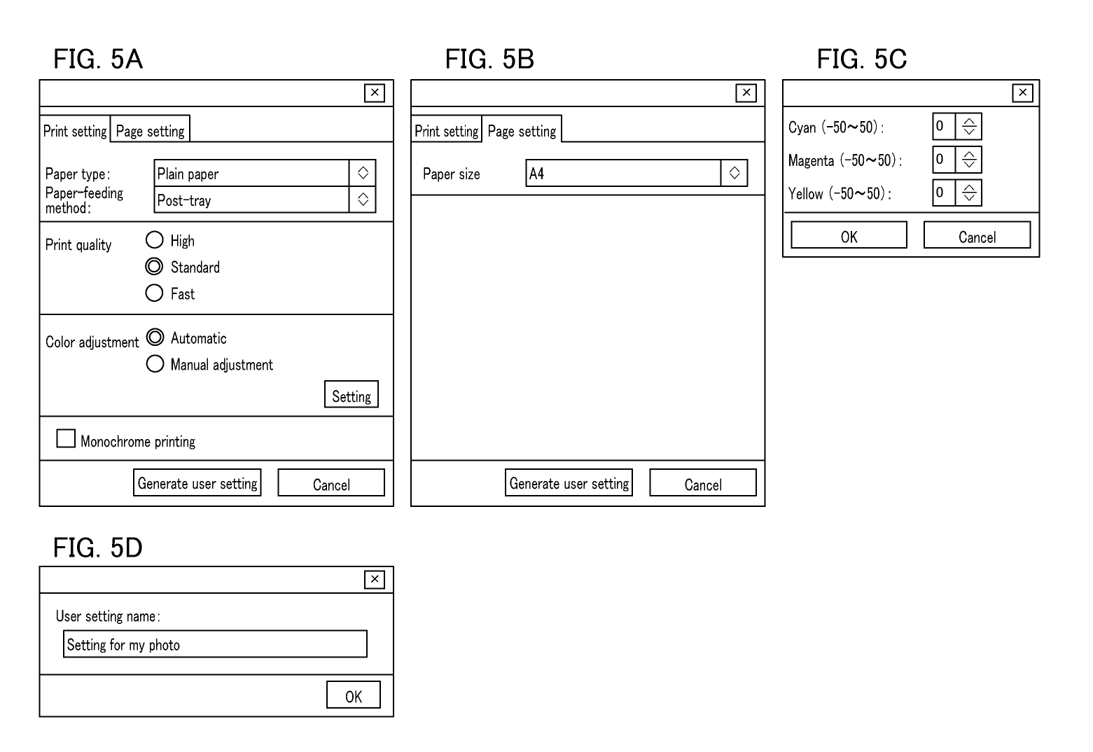

FIG. 5 is a diagram illustrating an example of a user setting generation dialogue. The user setting generation unit 313 generates and displays a user setting generation dialogue. When a user performs a selection operation on a user setting generation dialogue, the user setting generation unit 313 generates a user setting depending on the selection operation. The user setting generation dialogue is constituted by tabs such as “print setting” or “page setting”, and has a “generate user setting” button and a “cancel” button.

All of the setting items supported by the printer 200 are displayed on a user setting generation dialogue. For example, when the printer 200 supports functions such as “frameless printing” or “double-sided printing”, these setting items are also displayed on the user setting generation dialogue.

FIG. 5A shows the UI configuration of the “print setting” tab. The user setting generation unit 313 displays the set values corresponding to the setting items “paper type” and “paper-feeding method” on the “print setting” tab in the pull-down format. Also, the user setting generation unit 313 displays radio buttons indicating the set values corresponding to the setting items “print quality” and “color adjustment”. Also, the user setting generation unit 313 displays a check box indicating the setting item “monochrome printing”. When the check box indicating the setting item “monochrome printing” is checked, monochrome printing is set to “ON”. When the check box is turned back to blank, monochrome printing is set to “OFF”.

FIG. 5B shows the UI configuration of the “page setting” tab. The user setting generation unit 313 displays a set value corresponding to the setting item “paper size” on the “page setting” tab in the pull-down format. After each time the setting items and the set values has been selected on the “print setting” tab shown in FIG. 5A and the “page setting” tab shown in FIG. 5B, the user setting generation unit 313 executes processing for eliminating a conflict between setting items.

When the “manual adjustment” is selected as a set value corresponding to the setting item “color adjustment” in the “print setting” tab shown in FIG. 5A and the “setting” button is depressed, the user setting generation unit 313 displays the color adjustment dialogue shown in FIG. 5C. The color adjustment dialogue displays set values corresponding to the setting items “color adjustment (cyan)”, “color adjustment (magenta)”, and “color adjustment (yellow)”. Since each of the set values is a value in the range of −50 to +50, spin buttons by which numeral values in the range of −50 to +50 can be input are displayed on the color adjustment dialogue.

FIG. 5D shows an example of a user setting name input dialogue. When the “generate user setting” button included in the user setting generation dialogue is depressed, the user setting generation unit 313 displays a user setting name input dialogue. A text box for inputting a character string is displayed on the user setting name input dialogue. When a user inputs a character string on the text box, the user setting generation unit 313 determines the character string as the set value of the setting item “user setting”, i.e., user setting identification information. In the example shown in FIG. 5D, “setting for my photo” is determined as user setting identification information (for example, user setting name). The user setting generation unit 313 writes once the determined user setting identification information in a PPD file corresponding to the printer.

Also, the user setting generation unit 313 associates the current user setting, i.e., the setting items and the set values, which have been selected in the setting items upon pressing the “generate user setting” button, with identification information about the user setting, and stores the resulting user setting in the user setting save file 311.

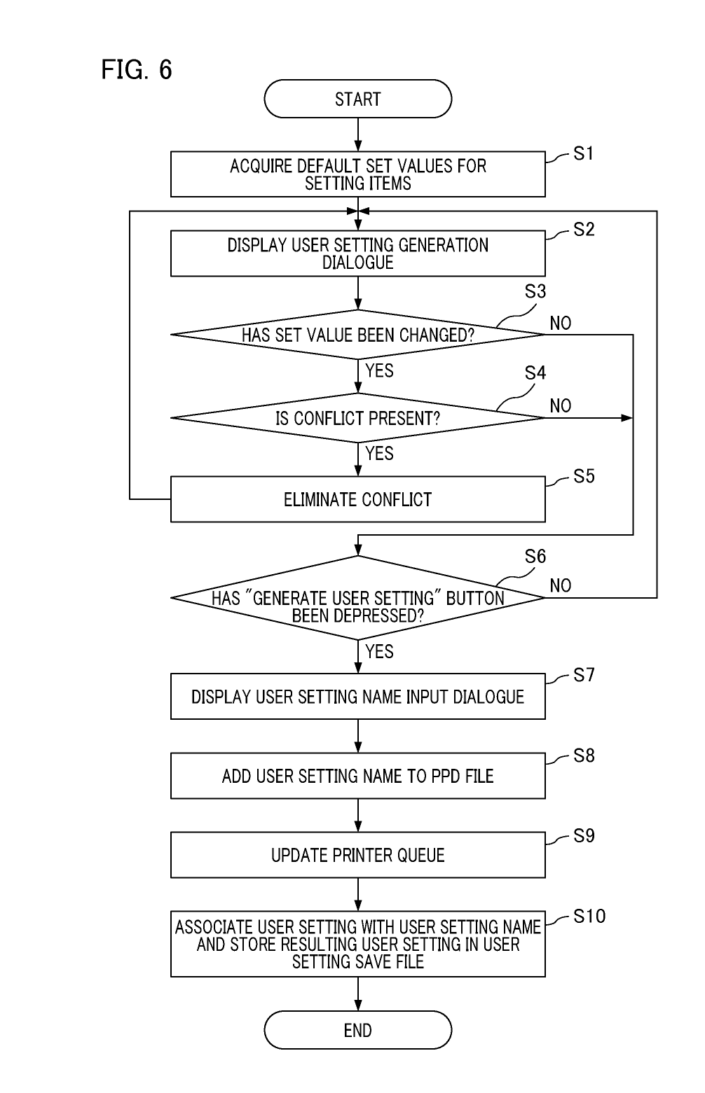

FIG. 6 is a flowchart illustrating user setting generation processing. The user setting generation unit 313 is activated in accordance with a user's operation. The method for activating the user setting generation unit 313 is the same as the activation of a typical application such as a method for executing a command, a method for executing a shortcut on a screen, or the like.

Firstly, the user setting generation unit 313 acquires default set values for the setting items corresponding to the printer 200 from the printer setting information DB 312 (step S1). In other words, the user setting generation unit 313 sets the setting items and the default set values as the initial user setting. The user setting generation unit 313 displays the acquired set values as the set values for the setting items on the user setting generation dialogue (step S2).

Next, the user setting generation unit 313 determines whether or not any one of the set values for the setting items has been changed based on a user's selection operation on the user setting generation dialogue (step S3). When no set value has been changed, the process advances to step S6. When any one of the set values has been changed, the initial user setting is updated with a new user setting using the changed set value, and then the process advances to step S4.

In step S4, it is determined whether or not a conflict (mismatch) between setting items occurs through the inspection of the set values for all of the setting items included in the current user setting (step S4). When no conflict occurs, the process advances to step S6. When a conflict occurs, the user setting generation unit 313 executes conflict elimination processing (step S5), and the process returns to step S2.

Hereinafter, a description will be given of an example of conflict elimination processing. For example, the setting item “paper type” and the setting item “print quality” are in a mutually-dependent relationship between setting items. For example, when “plain paper” has been selected as a set value corresponding to “paper type”, it is assumed that any one of three set values “high”, “standard”, and “fast” can be set as a set value corresponding to “print quality”. On the other hand, when “glossy paper” has been selected as a set value corresponding to “paper type”, it is assumed that only one set value “high” can be set as a set value corresponding to “print quality”.

When the user setting generation unit 313 changes the set value of “paper type” to “glossy paper” while the set value “plain paper” and the set value “fast” are set simultaneously as “paper type” and “print quality”, respectively, “glossy paper” is incompatible with “fast”. In other words, in this case, a conflict occurs between the setting items “paper type” and “print quality”. Thus, the user setting generation unit 313 eliminates such conflict by changing, for example, the set value of “print quality” to “high” which may be compatible with the set value “glossy paper” for “paper type”.

Also, when “glossy paper” has been selected as a set value for the setting item “paper type”, it is assumed that two set values “high” and “standard” can be simultaneously set as the set values for the setting item “print quality”. Here, when the user setting generation unit 313 changes the set value of “paper type” to “glossy paper” while the set values “plain paper” and “fast” are simultaneously set, “glossy paper” may not be compatible with “fast”, resulting in a conflict state. Thus, in such a case, the user setting generation unit 313 changes the set value of “print quality” to a default set value “standard” which may be compatible with “glossy paper”. The user setting generation unit 313 acquires the default set value from the printer setting information DB 312.

In step S6, the user setting generation unit 313 determines whether or not a “generate user setting” button on the user setting generation dialogue has been depressed (step S6). When the “generate user setting” button has not been depressed, the process returns to step S2. When the “generate user setting” button has been depressed, the user setting generation unit 313 displays a user setting name input dialogue (step S7). When a user inputs a user setting name on the user setting name input dialogue, the user setting generation unit 313 writes once the user setting name in a PPD file (step S8).

Next, the user setting generation unit 313 executes an 1padmin command to thereby update the queue of the printer (step S9). In other words, the user setting generation unit 313 executes an 1padmin command, and updates the PPD file, which has already been copied in the CUPS 302, with the PPD file in which the user setting name has been written in step S8. Then, the user setting generation unit 313 associates a user setting, which includes the setting items and the set values selected upon depression of the “generate user setting” button, with a user setting name, and stores the resulting user setting in the user setting save file 311 (step S10).

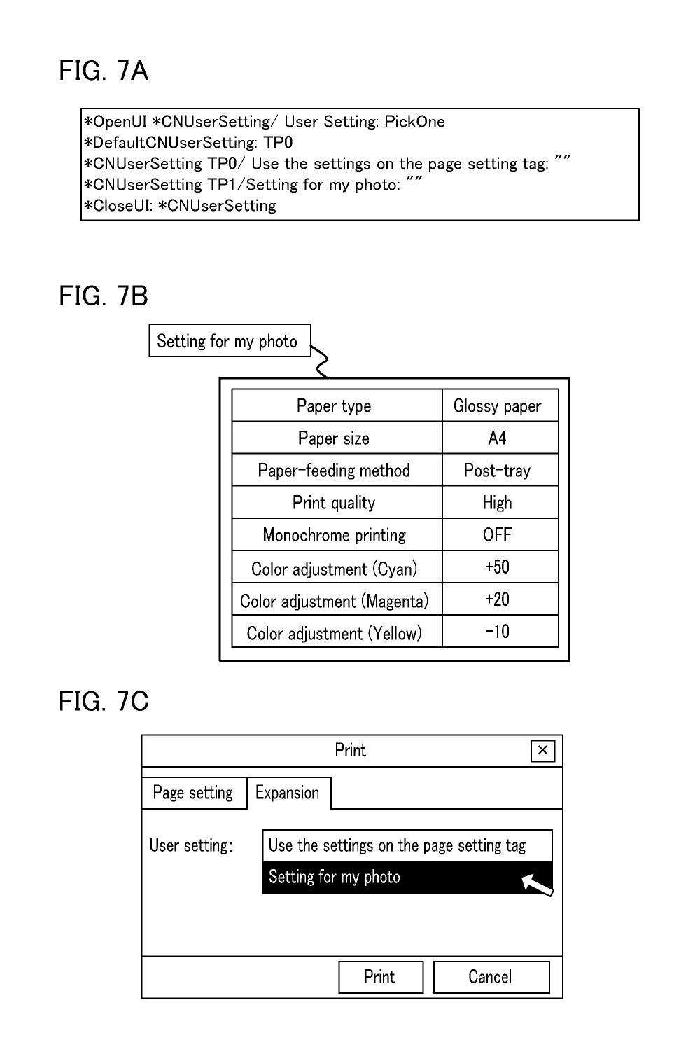

FIG. 7 is a diagram illustrating an example of a PPD file, a user setting, and a print setting dialogue according to the first embodiment of the present invention. FIG. 7A shows an example of description of a PPD file associated with a user setting by way of a user setting name. In the PPD file shown in FIG. 7A, the additional “setting for my photo” is added as a set value for the setting item “user setting”. Thus, the application 301 displays “setting for my photo” as the set value for “user setting” on the “extension” tab on the print setting dialogue in accordance with the description content of the PPD file.

FIG. 7B shows an example of a user setting. The user setting is in association with the PPD file shown in FIG. 7A by way of the user setting name “setting for my photo”. FIG. 7C shows an example of a print setting dialogue to be displayed in accordance with the description content of the PPD file shown in FIG. 7A. In the print setting dialogue, the additional “setting for my photo” is added as a set value for the setting item “user setting” on the “extension” tab.

Hereinafter, a description will be given of print processing of the first embodiment. A user generates and edits original data using the application 301. Before a user requests printing, a user activates a print setting dialogue to make a print setting.

On the print setting dialogue, a user selects set values for the setting items (for example, “paper size”, “paper type”, and “paper-feeding method”) displayed on the “page setting” tab. Also, a user selects a set value for the setting item “user setting” displayed on the “extension” tab. When a user selects a set value on the print setting dialogue, the application 301 starts print processing. The application 301 passes PS data and information regarding print settings to the CUPS 302 in the option format of the CUPS.

For example, assume the case where a user has selected “use the settings on the page setting tag” on the “extension” tab shown in FIG. 7C. In this case, information regarding print settings includes the set values selected on the “page setting” tab, and the set value “use the settings on the page setting tag” for the user setting selected on the “extension” tab. Also, for example, when a user has selected “setting for my photo” on the “extension” tab, information regarding print settings includes the set value “setting for my photo”.

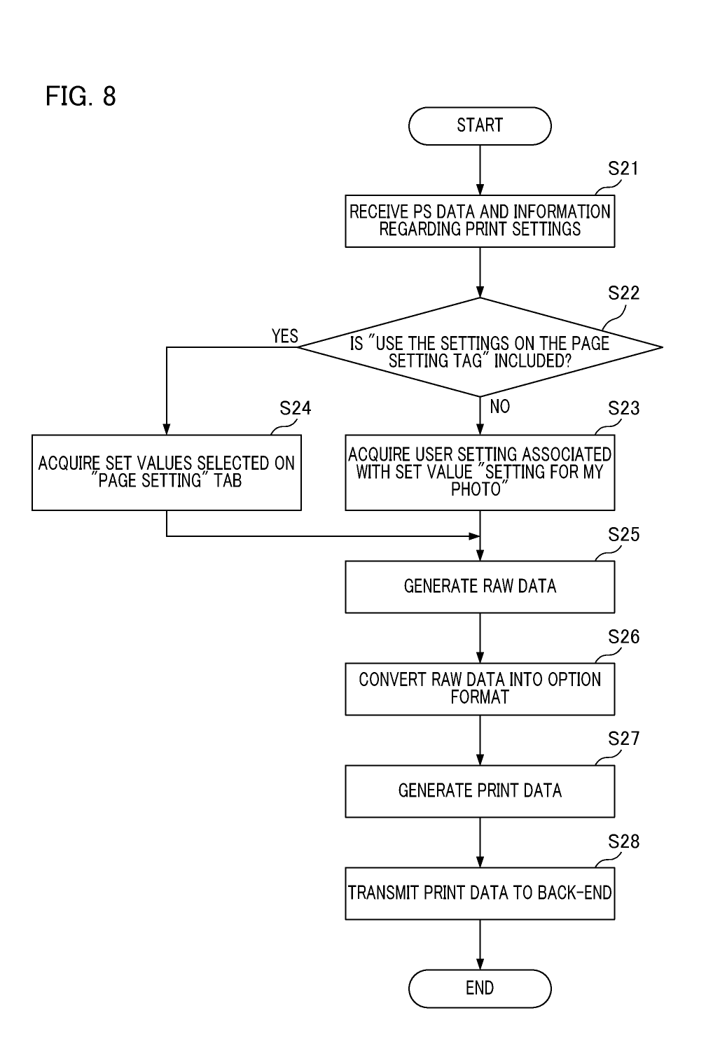

FIG. 8 is a flowchart illustrating PS filter program operation processing according to the first embodiment. Firstly, the PS filter program 306 receives PS data and information regarding print settings from the application 301 via the scheduler 304 (step S21). Next, the PS filter program 306 determines whether or not the received information regarding print settings includes “use the settings on the page setting tag” (step S22). Information regarding print settings including “use the settings on the page setting tag” functions as control information indicating that a print setting is made by using the print settings selected on the “page setting” tab of the print setting dialogue, that is, the print settings included in the PPD file 310.

When information regarding print settings includes “use the settings on the page setting tag”, the PS filter program 306 acquires the set values, which have been selected on the “page setting” tab, included in information regarding print settings (step S24), and the process advances to step S25.

When information regarding print settings does not include “use the settings on the page setting tag”, the PS filter program 306 acquires the set value for the user setting, which has been selected on the “extension” tab, included in information regarding print settings. Information regarding print settings not including “use the settings on the page setting tag” functions as control information indicating that a print setting is made by using the user setting associated with the set value for the user setting selected on the “extension” tab.

In this example, the PS filter program 306 acquires “setting for my photo”. The PS filter program 306 acquires a user setting associated with the set value “setting for my photo” for the acquired user setting from the user setting save file 311 (step S23). The PS filter program 306 determines the acquired user setting as a print setting to be applied upon generation of print data. In other words, the PS filter program 306 makes a print setting for print processing using the user setting. Note that the user setting acquired in step S23 is the option format of the CUPS 302.

Next, the RAW data generation program 307 provided in the PS filter program 306 converts PS data into RGB RAW data (step S25). With this arrangement, RAW data is generated. Next, the print data generation program 308 converts the set values into the option format of the print data generation program 308 (step S26). More specifically, the print data generation program 308 converts the option format of the set values included in the user setting.

If the set values selected on the “page setting” tab have been acquired in step S24, the setting items corresponding to the set values are missing for the setting items that can be set by the print data generation program 308. Thus, in this case, the print data generation program 308 acquires the set values corresponding to the default setting items stored in the printer setting information DB 312 in advance. The print data generation program 308 set the acquired set values and the set values selected on the “page setting” tab as the targets for converting into the option format.

The print data generation program 308 generates print data using the set values of which the option format has been converted in step S26 (step S27). Then, the print data generation program 308 transmits the generated print data to the back-end 309 (step S28). The back-end 309 transmits print data to the printer 200. The printer 200 outputs the received print data from the back-end 309. According to the information processing apparatus (computer) of the first embodiment, print settings can be made for the setting items that are not displayed on the print setting dialogue activated by an application. Further, according to the information processing apparatus of the first embodiment, a mismatch in print settings may be prevented.

Next, a description will be given of a second embodiment of the present invention. In the second embodiment, a PPD file in the initial state has other set values in addition to “use the settings on the page setting tag” as the set values for a user setting.

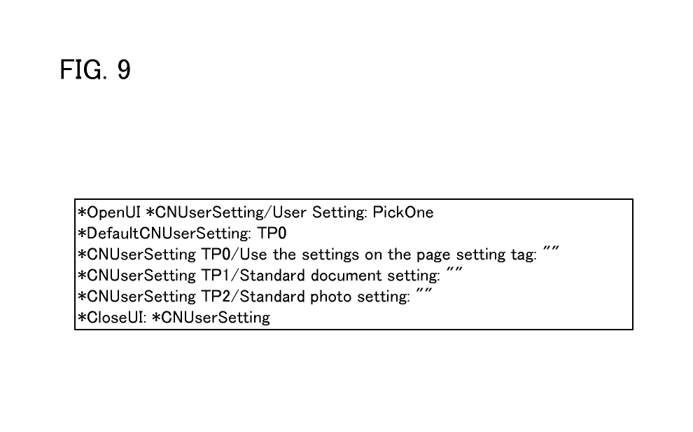

FIG. 9 is a diagram illustrating an example of description of a PPD file in the initial state according to the second embodiment. As the set values for the setting item “user setting”, “use the settings on the page setting tag”, “standard document setting”, and “standard photo setting” are described in the PPD file shown in FIG. 9. Print settings corresponding to “standard document setting” and “standard photo setting” are stored in the printer setting information DB 312 in advance.

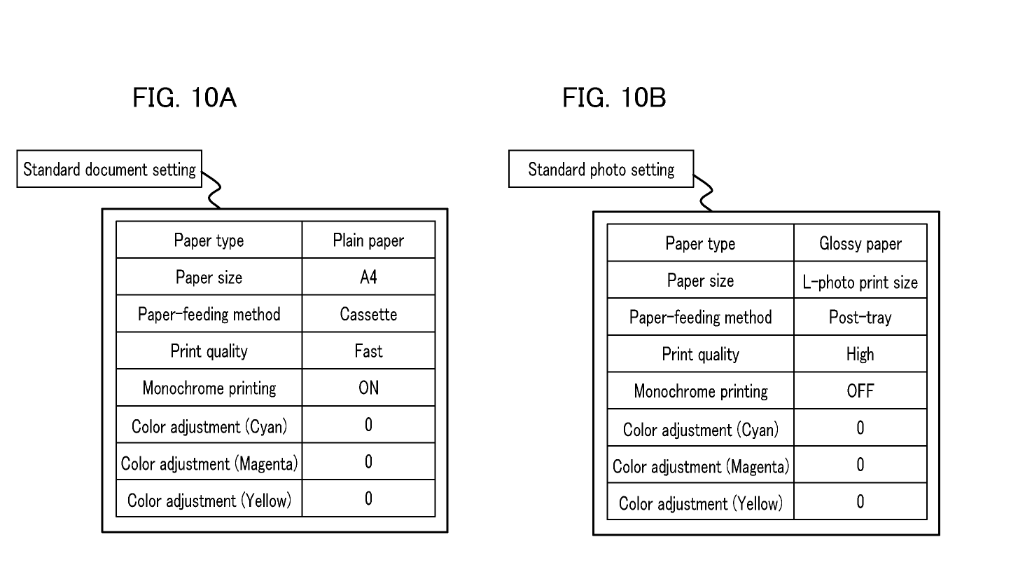

FIG. 10 is a diagram illustrating an example of description of a user setting in the initial state according to the second embodiment. In the initial state, a user setting associated with the standard document setting shown in FIG. 10A and a user setting associated with the standard photo setting shown in FIG. 10B are stored in the user setting save file 311 in advance. In other words, the user setting shown in FIG. 10A is in association with a PPD file by way of the standard document setting. Also, the user setting shown in FIG. 10B is in association with a PPD file by way of the standard photo setting.

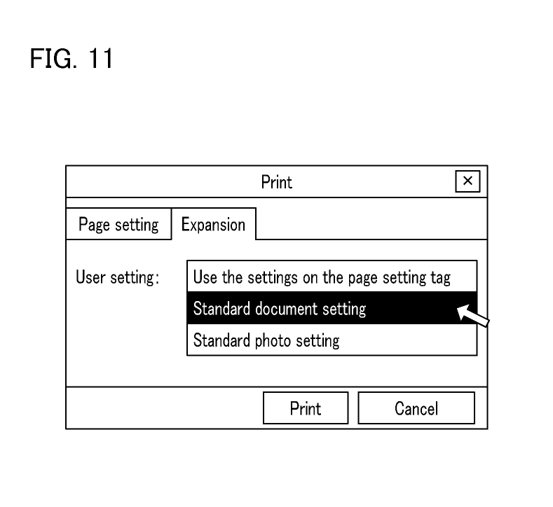

FIG. 11 is a diagram illustrating an example of a print setting dialogue according to the second embodiment. The application 301 displays the print setting dialogue shown in FIG. 11 in accordance with the description content of the PPD file shown in FIG. 9. On the print setting dialogue, “use the settings on the page setting tag”, “standard document setting”, and “standard photo setting” are displayed as the set values for the setting item “user setting” in the pull-down format.

When a user selects, for example, “standard document setting” as the set value for the user setting on the print setting dialogue, the application 301 transmits “standard document setting” as information regarding print settings to the CUPS 302. The PS filter program 306 of the CUPS 302 acquires a user setting corresponding to the received “standard document setting” from the user setting save file 311, and generates print data using the acquired user setting. According to the information processing apparatus of the second embodiment, print data may be generated using a user setting corresponding to the set values for the selected “user setting”.

Next, a description will be given of a third embodiment. In the third embodiment, the setting items included in the user setting generated by the user setting generation unit 313 are missing for all of the setting items corresponding to the printer 200. In the third embodiment, when the user setting corresponding to user setting identification information selected on a print setting dialogue is missing for the print settings corresponding to the printer 200, the PS filter program 306 executes the following processing.

The PS filter program 306 makes a print setting for print processing using a user setting corresponding to user setting identification information and a default print setting stored in the printer setting information DB 312 in advance. In other words, the PS filter program 306 supplements the print settings included in the user setting with the default print settings, and generates print data using the supplemented print settings. According to the information processing apparatus of the third embodiment, even when the print settings included in the user setting are missing for the print settings corresponding to the printer 200, the information processing apparatus may generate print data by supplementing the missing print settings with the default print settings.

According to the systems of the present embodiments described above, the print settings regarding the setting items which are not displayed on a print setting dialogue to be activated by an application may be made. Further, according to the systems, a mismatch in print settings may be prevented.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-025630 filed Feb. 9, 2011, which is hereby incorporated by reference herein in its entirety.

What is claimed is:

1. An information processing apparatus that performs a print setting for print processing executed by a print device, the information processing apparatus comprising:
a first storage unit configured to store information including a first print setting corresponding to the print device in advance;
a second storage unit configured to store information including a second print setting, which is a print setting corresponding to the print device, in which a conflict state between print settings has been eliminated; and
a print setting unit configured to perform a print setting for print processing using the first print setting or the second print setting,
wherein, when an application that selectably displays a print setting included in the first print setting stored in the first storage unit on a screen and receives control information indicating whether or not a print setting for print processing executed by the print device is made using either the print setting included in the first print setting selected on the screen or the second print setting stored in the second storage unit receives control information indicating that a print setting for print processing executed by the print device is made using the print setting included in the first print setting selected on the screen, the print setting unit makes a print setting for the print processing using the selected print setting, and
wherein, when the application receives control information indicating that a print setting for print processing executed by the print device is made using the second print setting, the print setting unit makes a print setting for print processing using the second print setting stored in the second storage unit.

2. The information processing apparatus according to claim 1, further comprising:
a conflict elimination unit configured to execute processing for eliminating a conflict state between print settings corresponding to the print device to thereby generate the second print setting; and
an association unit configured to associate the second print setting with identification information about the second print setting and store the associated information in the second storage unit as well as to associate the second print setting with the first print setting using identification information about the second print setting;
wherein the application displays identification information about the second print setting associated with the first print setting on the screen, and, when identification information about the second print setting has been selected on the screen, and receives control information indicating that a print setting for print processing executed by the print device is made using the second print setting to thereby transmit the control information to the print setting unit, and
wherein, when the print setting unit has received the control information from the application, the print setting unit makes a print setting for print processing using the second print setting corresponding to the selected identification information.

3. The information processing apparatus according to claim 2, wherein, when the second print setting corresponding to the selected identification information is missing for the print setting corresponding to the print device, the print setting unit makes a print setting for the print processing using the second print setting and a predetermined print setting.

4. A method for controlling an information processing apparatus that performs a print setting for print processing executed by a print device, wherein the information processing apparatus comprises a first storage unit configured to store information including a first print setting corresponding to the print device in advance and a second storage unit configured to store information including a second print setting, which is a print setting corresponding to the print device, in which a conflict state between print settings has been eliminated, the method comprising:
selectably displaying a print setting included in the first print setting stored in the first storage unit on a screen and receiving control information indicating whether or not a print setting for print processing executed by the print device is made using either the print setting included in the first print setting selected on the screen or the second print setting stored in the second storage unit; and
making a print setting for the print processing using the selected print setting when control information indicating that a print setting for print processing executed by the print device is made using the print setting included in the first print setting selected on the screen has been received or making a print setting for print processing using the second print setting stored in the second storage unit when the application has received control information indicating that a print setting for print processing executed by the print device is made using the second print setting.

5. A computer readable storage medium on which is stored a computer program for making a computer execute a method for controlling an information processing apparatus that performs a print setting for print processing executed by a print device, wherein the information processing apparatus comprises a first storage unit configured to store information including a first print setting corresponding to the print device in advance and a second storage unit configured to store information including a second print setting, which is a print setting corresponding to the print device, in which a conflict state between print settings has been eliminated, the method comprising:
selectably displaying a print setting included in the first print setting stored in the first storage unit on a screen and receiving control information indicating whether or not a print setting for print processing executed by the print device is made using either the print setting included in the first print setting selected on the screen or the second print setting stored in the second storage unit; and
making a print setting for the print processing using the selected print setting when control information indicating that a print setting for print processing executed by the print device is made using the print setting included in the first print setting selected on the screen has been received or making a print setting for print processing using the second print setting stored in the second storage unit when the application has received control information indicating that a print setting for print processing executed by the print device is made using the second print setting.
